(19) United States
(12) Patent Application Publication
(10) Pub. No.: US 2016/0224982 A1
(43) Pub. Date: Aug. 4, 2016

(54) VISA COMPLIANCE MONITORING SYSTEM

(71) Applicant: MasterCard International Incorporated, Purchase, NY (US)

(72) Inventors: Fabiano Vergari, West Bridgford (GB); Shweta J. Chaudhury, London (GB)

(21) Appl. No.: 15/009,333

(22) Filed: Jan. 28, 2016

(30) Foreign Application Priority Data
Jan. 29, 2015 (GB) 1501508.4

(51) Int. Cl. G06Q 20/40

(52) U.S. Cl. CPC G06Q 20/409

(57) ABSTRACT

A computer implemented method, at a processor, of tracking visa compliance of a person, the method comprising the steps of: receiving and storing payment card data associated with a payment card associated with the person; receiving and storing visa data associated with a country and the person; identifying transaction data containing a date and a location of transactions performed using the payment card; and creating immigration status data associated with the person based on the visa data and the transaction data.

### CROSS-REFERENCE TO RELATED APPLICATIONS

This application claims foreign priority to United Kingdom Patent Application No. 1501508.4 filed 29 Jan. 2015 entitled VISA COMPLIANCE MONITORING SYSTEM, the complete disclosure of which is expressly incorporated herein by reference in its entirety for all purposes.

### FIELD OF THE INVENTION

The present invention relates generally, but not exclusively, to immigration control and systems for monitoring visa compliance, in particular, to systems which are able to track the location of one or more visa holders and which are able to provide an indication of whether or not a visa holder has complied with the restrictions of their visa.

### BACKGROUND TO THE INVENTION

Although most countries have some form of border control at which people entering the country are required to go through some form of authorisation check, which might involve checking a person's visa and recording whether that person has entered the country, often no such checks are made when a person leaves the country. As such, there is often no record of when a particular person leaves a country.

As a result of this, border agencies often do not know whether or not a person who has entered a country and who only has conditional authorisation to remain in that country, such as a temporary visa, has left the country. As such, border agencies are often unable to tell whether or not a person has outstayed their visa by remaining in the country beyond the expiry date of their visa.

Many countries rely on strong sanctions against people who overstay their visas in order to deter people from doing so. For example, in the United Kingdom, if a person overstays their visa by more than 28 days they are not allowed to apply for further leave to remain in the United Kingdom from within the United Kingdom. If a person overstays their visa by more than 90 days, they may be barred from returning to the United Kingdom for at least 12 months. Much longer sanctions are also possible.

Currently, no effective systems exist for monitoring visa compliance. Emphasis is placed on encouraging voluntary departure for people who are not in possession of a visa permitting them to stay within a country. Costly compliance activities are sometimes undertaken by border authorities to actively pursue people who have outstayed their visas. Locating people who have expired visas in order to ascertain whether they are still within the country who provided their visa can be a drain on resources. Accordingly, there is a need to provide a technologically efficient means for ascertaining whether or not a person with an expired visa has remained in the visa issuing country.

### SUMMARY OF THE INVENTION

According to a first aspect of the invention, there is provided a computer implemented method, at a processor, of tracking visa compliance of a person, the method comprising the steps of: receiving and storing payment card data associated with a payment card associated with the person; receiving and storing visa data associated with a country and the person; identifying transaction data containing a date and a location of transactions performed using the payment card; and creating immigration status data associated with the person based on the visa data and the transaction data.

Advantageously, such a computer implemented method enables the visa compliance of a person (cardholder) entering a country using a visa to be efficiently monitored using transaction data created by the use of a payment card belonging to the person.

The method of the first aspect of the invention may be performed at a secure server hosted within a payment processing network.

This method may be performed by a tracking server.

In one embodiment of the first aspect of the invention, the visa data may comprise one or more of a visa number, a visa start date, and a visa end date.

In one embodiment of the first aspect of the invention, the step of identifying transaction data may be carried out over a specified period of time.

In one embodiment of the first aspect of the invention, the step of identifying transaction data may comprise the steps of: accessing a database containing identification information suitable for uniquely identifying the payment card at the end of or after the specified period of time; analysing transactions performed during the specified period of time for the identification information to identify transactions which contain the identification information.

In one embodiment of the first aspect of the invention, the identification information may be the payment card data.

In one embodiment of the first aspect of the invention, the specified period of time may be calculated based on a visa start date and/or a visa end date.

In one embodiment of the first aspect of the invention, the specified period of time may begin 4 to 8 weeks before a visa start date.

In one embodiment of the first aspect of the invention, the specified period of time may end 4 to 8 weeks after a visa end date.

In one embodiment of the first aspect of the invention, the step of creating immigration status data may occur after the specified period of time has elapsed.

In one embodiment of the first aspect of the invention, the immigration status data may indicate whether or not the person entered the country between a visa start date and a visa end date.

In one embodiment of the first aspect of the invention, the immigration status data may indicate whether or not the person left the country between a visa start date and a visa end date.

Advantageously, the generated immigration status data may be used to identify persons who have or have not complied with their visa restrictions.

In one embodiment of the first aspect of the invention, payment card data associated with a plurality of payment cards belonging to the person may be received and stored and the transaction data containing a date and a location of transactions performed using each of the payment cards may be identified.

In one embodiment of the first aspect of the invention, the payment card data associated with a plurality of payment cards belonging to a plurality of persons may be received and stored and the transaction data containing a date and a location of transactions performed using each of the payment cards may be identified.

In one embodiment of the first aspect of the invention, each of the payment cards may belong to a single person.

In one embodiment of the first aspect of the invention, the payment card data may comprise payment card credentials of the payment card which include one or more of a person name and a Primary Account Number.

In one embodiment of the first aspect of the invention, the step of identifying transaction data may be carried out by accessing a payment processing network.

According to a second aspect of the invention, there is provided a server configured to perform the method of any of the embodiments of the first aspect of the invention.

According to a third aspect of the invention, there is provided an electronic device comprising: one or more processors; and memory comprising instructions which, when executed by one or more of the processors, cause the device to operate in accordance with the method of any of the embodiments of the first aspect of the invention.

According to a fourth aspect of the invention, there is provided a computer readable medium having computer executable instructions stored thereon for implementing the method of any of the embodiments of the first aspect of the invention.

According to a fifth aspect of the invention, there is provided a network component configured to implement the method of any of the embodiments of the first aspect of the invention.

### BRIEF DESCRIPTION OF THE DRAWINGS

Embodiments of the present invention will now be described, by way of example only, with reference to the accompanying drawings, in which:

FIG. 1 depicts an operating model of the parties involved when a visa compliance tracking system is used to track the compliance of a person entering and leaving a country;

FIG. 2 depicts a timeline of various transactions made using a payment card by a person, the processing of transaction data produced by said transactions by a tracking server, and the use, by a border agency, of data produced by the tracking server based on the transaction data;

FIG. 3 is a flow diagram showing the steps involved in an exemplary visa compliance tracking process involving the parties shown in FIGS. 1 and 2;

FIG. 4 is a flow diagram which depicts the steps involved in a further visa compliance tracking process; and

FIG. 5 is a flow diagram which depicts the steps which occur, at a tracking server, in a further method for tracking visa compliance of a person.

### DETAILED DESCRIPTION

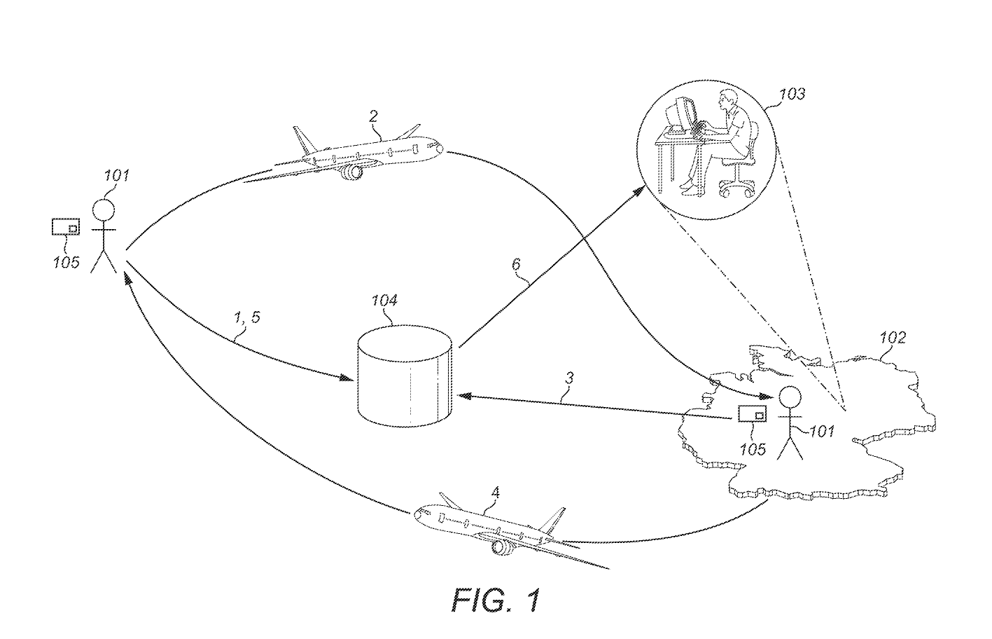

FIG. 1 depicts an operating model of the parties involved when a visa compliance tracking system is used to track the compliance of a cardholder entering and leaving a country. FIG. 1 depicts a cardholder 101, a country 102, a border agency 103 associated with said country 102, a tracking server 104 and a payment card 105 belonging to the cardholder 101.

Where the term cardholder has been used, it will be understood that it is intended to cover any person who is associated with a particular payment card. For example, where a subsidiary card of a main account is used by a person who is not the account holder (e.g. a family member or employee of the main account holder), but who is still associated with the subsidiary card, that person may be considered to be a cardholder. A cardholder is considered to be any person who is associated with a payment card.

The payment card 105 may be one of a credit, debit, prepaid or charge card.

Although only a single cardholder 101 and payment card 105 are depicted, it will be understood that this system could be used to track the compliance of multiple cardholders each with one or more payment cards.

In one or more embodiments, the tracking server 104 may not necessarily be a server. The tracking server 104 may be any system, network component, electronic device comprising one or more processors and memory or computer readable medium having computer executable instructions stored thereon suitable for performing the below outlined functionality.

The cardholder 101 is not a citizen of country 102 but is in possession of a valid visa which enables them to enter the country 102 for a limited amount of time, for example, 90 days.

At step 1, the cardholder 101 registers their payment card 105 with the tracking server 104 and/or the border agency 103 (not shown).

At step 2, the cardholder 101 then travels to the country 102, and, upon arrival, presents their visa to the border agency 103 who checks that the cardholder 101 is authorised to enter the country 102 at the time of their arrival.

At step 3, the use of the payment card 105 by the cardholder 101 is tracked by the tracking server 104 whilst the cardholder is in the country 102. The tracking server 104 may, for example, obtain the details of one or more of the date, time, and location of any transactions made by the cardholder 101 using the payment card 105.

This transaction data may be obtained by accessing a payment processing network over which the transactions are performed.

The time for which the tracking server 104 tracks the use of the payment card 105 is known as a tracking window or event window. There may be one or more tracking windows during which the use of the payment card 105 is tracked.

In order to enable the tracking server 104 to identify the transaction data produced by use of the payment card 105 during a tracking window, there may be provided a database (not shown) containing identification information, such as Primary Account Numbers (PANs), suitable for uniquely identifying any payment cards which have been registered with the tracking server 104 including payment card 105. The tracking server 104 may then interrogate this database each time a transaction is made using the payment card 105 or any other registered payment card to check whether it needs to obtain the transaction data for the transaction in question.

The database may be in the form of an input data table of identification information. The tracking server 104 may interrogate the database (input data table) at the end of a tracking or event window, analyse the transactions performed during that window to identify those containing the relevant identification information and generate one or more statuses or sets of immigration status data based on the identified transactions.

It will be understood that, where the term status is used, the status can be considered to be status data.

The tracking server 104 may be a piece of code or algorithm, which is executed to interrogate the input data table. The tracking server 104 uses the input data table of identification information, matches and extracts transactions containing the given identification information (thus ‘obtaining’ the required transaction data), performs its analysis of the transactions, generates statuses or sets of immigration status data based on the analysed transactions, and saves these statuses or sets of immigration status data in a data table.

All these steps may be performed on a secure server or servers. The secure server(s) may be hosted within a payment processing network.

The input table may be provided to the tracking server 104 by the border agency 103, and the status data table may be sent back to the border agency 103 by the tracking server 104. This may occur where, for example, at step 1 the cardholder 101 registers their payment card 105 with the border agency.

In an alternative embodiment, a spare data field in the authorisation message, which is sent when a transaction is made using the registered payment card 105 or any other registered payment card, may be created.

The spare data field may be populated with a suitable flag which causes a notification to be sent from the payment processing network over which the transaction is being performed to the tracking server 104 during the transaction authorisation process.

The notification may let the tracking server 104 know that it needs to obtain the transaction data for the transaction in question.

At step 4, the cardholder 101 leaves country 102. The tracking server 104 continues to track the use of the payment card 105 by the cardholder 101.

At step 5, the cardholder 101, who has now left country 102, performs a transaction using payment card 105. The tracking server 104 ascertains that the transaction was performed outside of country 102.

At step 6, the tracking server 104 sends a message to the border agency 103 signifying that the cardholder 101 has left country 102.

It will be understood that the system shown in FIG. 1 is merely representative and there are various ways in which the system may be implemented, many of which will be discussed in what follows.

For example, one variation is that, following registration step 1, the tracking server 104 continually tracks the use of the payment card 105 by the cardholder 101 and continually provides the border agency 103 with information about the estimated location of the cardholder 101, based on transaction data produced by the use of payment card 105.

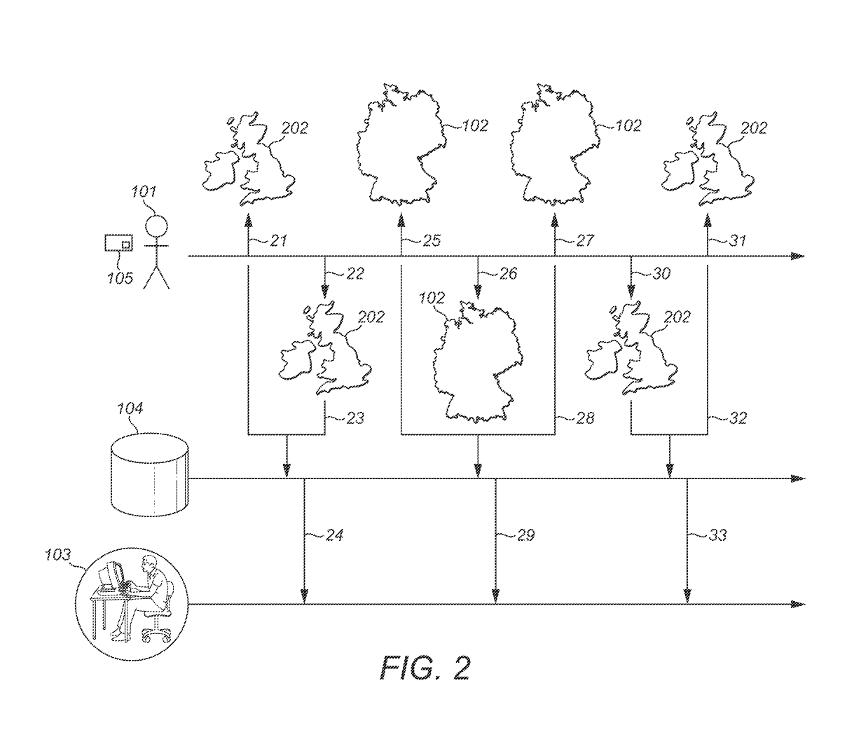

FIG. 2 depicts a timeline of various transactions made using the payment card 105 by the cardholder 101, the processing of the transaction data produced by said transactions by the tracking server 104, and the use, by a border agency 103, of data produced by the tracking server based on the transaction data.

It is assumed that the payment card 105 has been registered with the tracking server 104 or the border agency 103, as per step 1 shown in FIG. 1.

At step 21, the cardholder 101 performs a transaction using payment card 105 when located in country 202.

At step 22, the cardholder 101 makes a further transaction using payment card 105 when located in the country 202.

At step 23, the tracking server 104 is able to infer that the cardholder 101 is located in country 202 based on transaction data (including date and location data for each transaction) produced at steps 21 and 22 obtained by the tracking server 104.

The tracking server 104 may obtain the transaction data by accessing a payment processing network over which the transactions are performed or by any of the aforementioned means.

At step 24, the tracking server 104 may, optionally, notify the border agency 103 of the location of the cardholder 101 and may pass on date and corresponding location data to the border agency 103.

At steps 25, 26 and 27, the cardholder 101 performs three respective transactions using the payment card 105, after having travelled from country 202 to country 102.

At step 28, the tracking server 104 obtains, via any of the aforementioned mechanisms as detailed in the description of the other embodiments described herein, and makes use of transaction data (including date and location data for each transaction) produced by each of the transactions performed at steps 25, 26 and 27 to infer that the cardholder 101 is located in country 102.

At step 29, the tracking server 104 may send a message to border agency 103 indicating that the cardholder 101 is located in the country 102 and may pass on date and corresponding location data to the border agency 103.

At steps 30 and 31, the cardholder 101 performs respective transactions using payment card 105 whilst located in country 202, after having travelled from country 102 back to country 202.

At step 32, the tracking server 104 obtains, via any of the aforementioned methods, and makes use of transaction data (including date and location data for each transaction) produced by each of the transactions performed at steps 30 and 31 to infer that the cardholder 101 is now located in country 202.

At step 33, the tracking server 104 sends a message to the border agency 103 indicating that it is likely that cardholder 101 has left country 202 and may pass on date and corresponding location data to the border agency 103.

The border agency 103 may make use of the information provided by the tracking server 104 at steps 24, 29 and 33 in order to ascertain whether the cardholder 101 has complied with the conditions of their visa, for example, by overlaying the start date of the visa and the end data of the visa with date and location data provided by the tracking server 104 in steps 24, 29 and 33.

In another embodiment, the tracking server 104 may have access to the visa information of the cardholder 101, for example, by having direct access to a database within which the visa information is stored. In this embodiment the tracking server 104 would be able to provide the border agency with an indication of whether or not the cardholder 101 is complying with the conditions of their visa, for example at one or more of steps 24, 29 and 33.

In yet another embodiment, steps 23 and 28 may not occur and the tracking server 104 may obtain, via any of the aforementioned methods, and make use of the transaction data produced at each of steps 21, 22, 25, 26, 27, 30 and 31 at step 33 to infer that the cardholder 101 is now located in country 202.

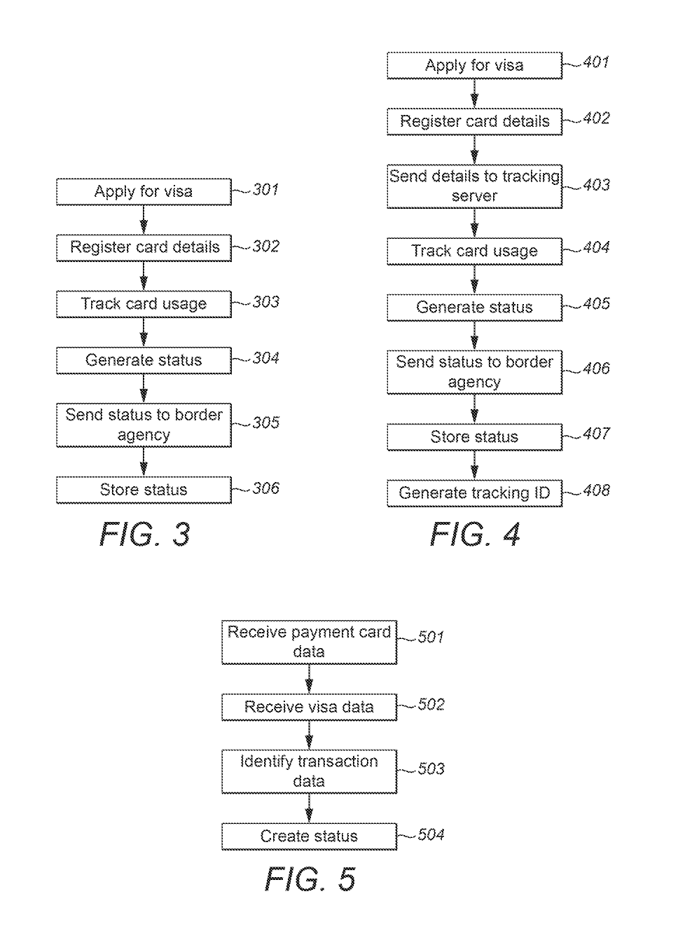

FIG. 3 is a flow diagram showing the steps that occur in an exemplary visa compliance tracking process involving the parties shown in FIGS. 1 and 2.

At step 301, a cardholder 101 applies for a visa for country 102 and is granted a visa.

At step 302, the cardholder 101 registers the details of a payment card 105, belonging to the cardholder 101, with a tracking server 104 or a border agency 103. The cardholder 101 may also register additional details. For example, the details registered by the cardholder 101 with the tracking server 104 or the border agency 103 may include one or more of the cardholder's full name, passport number, passport issuing country, a 16 digit primary account number (PAN) of the payment card 105 and the cardholder's visa details (e.g. including one or more of visa number, start date and end date). The details provided by the cardholder 101 are stored by the tracking server 104, for example, on a database hosted by the tracking server 104 or by the border agency 103.

At step 303, the tracking server 104 tracks the usage of the payment card 105 using any of the aforementioned mechanisms as detailed in the description of the other embodiments described herein.

The tracking server 104 may track all transactions made using the payment card 105 (for example, by accessing the payment processing network over which the transactions are performed) and merge the data produced by these transactions onto the database. The tracking server 104 may obtain details of the date and location of all transactions performed using the payment card 105.

The tracking server 104 may track the payment card 105 for a predetermined or specified period of time (i.e. a tracking window). This predetermined period of time or tracking window may be determined based on the start date and the end date of the visa belonging to the cardholder 101. For example, the tracking window may begin four to eight weeks before the start date of the cardholder's visa and may end four to eight weeks after the end date of the cardholder's visa.

In an alternative embodiment the tracking server 104 may begin tracking the use of the payment card 105 when it receives an alert from the border agency 103 (shown in FIGS. 1 and 2) indicating that the cardholder 101 has entered the country 102.

In another embodiment, the tracking server 104 is configured to continually track the usage of the payment card 105 and the tracking server 104 may not be provided with any of the cardholder's visa details as these details may not be required.

At step 304, which occurs after the tracking window during which the transactions of payment card 105 are tracked has elapsed, the tracking server 104 may generate a status or immigration status data for the card holder 101. Exemplary statuses include the following:
“Entered and departed the country within the issued visa dates”
“Entered the country within issued visa dates, but departed the country post visa expiry date”
“Entered the country within issued visa dates, departed the country, but unsure when”
“Entered the country within issued visa dates, not departed the country until four to eight weeks past visa expiry date”
“Entered the country within issued visa dates, unsure if departed the country”
“Unsure if entered or departed the country within visa dates”

The above listed statuses are merely exemplary and are by no means an exhaustive list of suitable statuses which may be generated by the tracking server 104. The status may be generated by an automated algorithm, at the tracking server 104, which estimates the location of the cardholder 101 throughout the event window.

At step 305, the generated status is sent by the tracking server 104 to the border agency 103. The tracking server may pass on other details which have been stored by the tracking server 104 including cardholder name and passport number details.

Advantageously, the border agency 103 is provided with an indication of whether or not the cardholder 101 has complied with their visa restrictions.

At optional step 306, the tracking server 104 stores the generated status and points are assigned to the cardholder 101 based on the status types accumulated by the cardholder 101. Registered cardholders may then be able to view an online account and see how many points they have accumulated with each international visit.

FIG. 4 is a flow diagram which depicts the steps that occur in a further method for tracking visa compliance of a cardholder 101.

At step 401, the cardholder 101 applies for a visa for country 102 and the application is accepted by the border agency 103 who may also conduct any other usual entry checks.

At step 402, the cardholder 101 also provides the border agency 103 with the PAN of their payment card 105 or registers the PAN of their payment card 105 with the border agency 103. This may be a mandatory step or a voluntary step.

At step 403, the border agency 103 provides the tracking server 104 with one or more of the following bits of information: the cardholder's full name; passport number; passport issuing country; a 16 digit primary account number (PAN) of the payment card 105 if registered in step 402; and the cardholder's visa details (including one or more of visa number, start date and end date). These details are stored by the tracking server 104, for example, on a database hosted by the tracking server 104.

At step 404, the tracking process, outlined in the above discussion of step 303 occurs.

At step 405, after the tracking period is over, a status is generated for the cardholder 101 by the tracking server 104 based on estimated location of the cardholder 101 during the tracking window or period. The status could be one of the following exemplary values:
“Departed the country within issued visa date”
“Departed the country post visa expiry date”
“Departed the country, but unsure when”
“Not departed the country until four to eight weeks past visa expiry date”
“Unsure if departed the country”

The above listed statuses are merely exemplary and are by no means an exhaustive list of suitable statuses which may be generated by the tracking server 104. The status may be generated by an automated algorithm, at the tracking server 104, which estimates the location of the cardholder 101 throughout the event window.

At step 406, the status is passed on to the border agency 103 by the tracking server 104 along with the 16 digit PAN and/or visa details, if the 16 digit PAN and visa details were previously provided to the tracking server 104 by the border agency 103 at step 403. The border agency 103 may combine the statuses with any information stored on their own databases to refine their list of possible visa overstays.

At step 407, the same process ensues as occurred in step 306, shown in FIG. 3 and as described above.

At step 408, the cardholder 101 is given a unique tracking ID, generated by, for example, the tracking server 104 or the border agency 103, which can be used to view an account uniquely associated with the cardholder 101, for example, by accessing it through the internet, which shows the points that they have accumulated with each international visit. For future visa applications and/or entry clearance, the cardholder 101 may be able to submit their tracking ID to the relevant border agency who could either expedite their visa application should the points reflect a number of favourable statuses attributed to the cardholder 101 or prompt further investigations prior to granting the cardholder 101 with a visa should the points reflect a number of unfavourable statuses attributed to the cardholder 101.

Any border agency, like the example border agency 103 may be able to query a database of cardholder data hosted by, for example, the tracking server 104 using a cardholder unique tracking ID in order to obtain information relating to any registered cardholder 101 who provides them with such a unique tracking ID and any border agency, such as the example border agency 103, may be able to use such a tracking ID to assist in granting or refusing visa applications.

FIG. 5 is a flow diagram which depicts the steps which occur, at a tracking server 104, in a further method for tracking visa compliance of a cardholder 101.

This method may be performed at a processor, on a storage device or at a secure server hosted within a payment processing network.

At step 501, the tracking server receives and stores (on, for example, a database hosted by the tracking server 104) payment card data associated with a payment card 105 belonging to the cardholder 101.

The payment card data may be sent to the tracking server 104 by the border agency 103. The payment card data may comprise the PAN of the payment card 105. The border agency 103 may send an encrypted file containing the payment card data (e.g. the PAN) to the tracking server 104.

The tracking server 104 may receive payment card data associated with multiple payment cards each belonging to a cardholder 101.

At step 502, the tracking server 104 receives and stores (on, for example, a database hosted by the tracking server 104) visa data associated with a country 102 and a cardholder 101.

This data may be sent to the tracking server 104 by the border agency 103. The border agency 103 may send an encrypted file containing the visa data to the tracking server 104.

The tracking server 104 may receive visa data for multiple visas each associated with a country 102 and a cardholder 101.

The payment card and visa data may be uploaded onto secure servers by the tracking server 104.

At step 503, the tracking server 104 identifies transaction data containing a date and a location of transactions performed using the payment card 105.

The tracking server 104 may identify and obtain the transaction data by accessing a payment processing network over which the transactions are performed or by using any of the aforementioned mechanisms as detailed in the description of the other embodiments described herein.

At step 504, the tracking server 104 creates immigration status data associated with the person, or a cardholder status, based on the visa data and the transaction data.

The visa data may comprise one or more of a visa number, a visa start date, and a visa end date.

The step 503 of identifying and obtaining transaction data may be carried out over a period of time or over a tracking window. For example, the period of time may be calculated based on the visa start date and/or the visa end date. In one embodiment, the period of time may begin 4 to 8 weeks before the visa start date and/or may end 4 to 8 weeks after the visa end date.

A predetermined period of time or ‘tracking window’ may be defined for each set of payment card data associated with a payment card 105 belonging to a cardholder 101 received by the tracking server 104 during which step 503 is carried out for each of received set of payment card data.

Step 503 may be carried out by running an algorithm on, for example, a weekly, daily or hourly basis for each set of payment card data whose tracking or event window is currently open and/or whose event window has passed. The algorithm may extract transaction data needed for analysis, perform analysis and generate a status for each set of payment card data and save the statuses in a secure table on secure servers, for example at the tracking server 104. The table may be encrypted and sent back to border agency 103. This method of identifying a transaction and obtaining data may also be used in any of the embodiments described herein.

Alternatively, the algorithm may interrogate a transaction database of a payment processing network and create a subset of transactions for the received set of payment card data by only considering transactions for the listed PANs and only looking at transactions which occurred in the associated event windows for each PAN. The algorithm may then analyse the extracted data sub-set and infer the location of the cardholder 101 at various points in the event window, and generate an individual status for each set of payment card data and save the statuses in a secure table on secure servers for example, at tracking server 104.

The step 503 may be carried out multiple times, for example, whenever new transaction data is available.

The tracking server 104 may use the visa data to determine the period of time it will track a payment card 105 for.

The step 504 of creating immigration status data may occur after the tracking window has elapsed. As such, the status may be a final status which is attributed to the cardholder 101 and which is created a predetermined period of time after their visa has expired. This information may then be used by a border agency 103 to identify which cardholders 101 have outstayed their visas.

The immigration status data may indicate whether or not the cardholder 101 entered the country between the visa start date and the visa end date.

The immigration status data may indicate whether or not the cardholder 101 left the country between the visa start date and the visa end date.

The step 504 of creating immigration status data may occur on one or more occasions during the tracking window. As such, the status may be a current status which is attributed to the cardholder 101 and which can be updated throughout the period of time. The status may, for example, be updated by carrying out step 504 whenever the tracking server 104 identifies transaction data (step 503).

The tracking server 104 may receive and store the payment card data (step 501) and/or the visa data (step 502) after the aforementioned period of time has elapsed.

The tracking server 104 may identify transaction data containing a date and a location of transactions performed using the payment card 105 (step 503) after the aforementioned period of time has elapsed. For example, step 503 may occur after the aforementioned period of time, but before the tracking server 104 creates immigration status data.

Alternatively, step 503 may occur during the aforementioned period of time, for example, in real-time as the transaction data is created.

Although each of the above methods and processes is described with respect to the steps which occur when a single cardholder 101 makes use of the present system and the herein described variations thereof, it will be understood that the methods could equally be applied to the use of the present system and the herein described variations thereof by multiple cardholders 101 simultaneously. The above outlined methods and process can be applied to each cardholder 101 simultaneously.

The flow charts and descriptions thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the scope of the invention as set forth in the appended claims.

What is claimed is:

1. A computer implemented method, at a processor, of tracking visa compliance of a person, the method comprising the steps of:
receiving and storing payment card data associated with a payment card associated with the person;
receiving and storing visa data associated with a country and the person;
identifying transaction data containing a date and a location of transactions performed using the payment card; and
creating immigration status data associated with the person based on the visa data and the transaction data.

2. The method of claim 1, wherein the visa data comprises one or more of a visa number, a visa start date, and a visa end date.

3. The method of claim 1, wherein the step of identifying transaction data is carried out over a specified period of time.

4. The method of claim 3, wherein the step of identifying transaction data comprises the steps of:
accessing a database containing identification information suitable for uniquely identifying the payment card at the end of or after the specified period of time;
analysing transactions performed during the specified period of time for the identification information to identify transactions which contain the identification information.

5. The method of claim 4, wherein the identification information is the payment card data.

6. The method of any of claim 3, wherein the specified period of time is calculated based on a visa start date and/or a visa end date.

7. The method of claim 3, wherein the specified period of time begins 4 to 8 weeks before a visa start date.

8. The method of claim 3, wherein the specified period of time ends 4 to 8 weeks after a visa end date.

9. The method of claim any of claim 3, wherein the step of creating immigration status data occurs after the specified period of time has elapsed.

10. The method of any of claim 2, wherein the immigration status data indicates whether or not the person entered the country between a visa start date and a visa end date.

11. The method of any of claim 2, wherein the immigration status data indicates whether or not the person left the country between a visa start date and a visa end date.

12. The method of claim 1, wherein payment card data associated with a plurality of payment cards belonging to the person is received and stored and, wherein transaction data containing a date and a location of transactions performed using each of the payment cards is identified.

13. The method of claim 12, wherein the payment card data associated with a plurality of payment cards belonging to a plurality of persons is received and stored and, wherein transaction data containing a date and a location of transactions performed using each of the payment cards is identified.

14. The method of claim 13, wherein each of the payment cards belongs to a single person.

15. The method of claim 1, wherein the payment card data comprises payment card credentials of the payment card which include one or more of a person name and a Primary Account Number.

16. The method of claim 1, wherein the step of identifying transaction data is carried out by accessing a payment processing network.

17. A server configured to track visa compliance of a person, by:
receiving and storing payment card data associated with a payment card associated with the person;
receiving and storing visa data associated with a country and the person;
identifying transaction data containing a date and a location of transactions performed using the payment card; and
creating immigration status data associated with the person based on the visa data and the transaction data.

18. An electronic device comprising:
one or more processors; and
memory comprising instructions which, when executed by one or more of the processors, cause the device to:
receive and store payment card data associated with a payment card associated with the person;
receive and store visa data associated with a country and the person;
identify transaction data containing a date and a location of transactions performed using the payment card; and
create immigration status data associated with the person based on the visa data and the transaction data.

19. A non-transitory computer readable medium comprising computer executable instructions which when executed by a computer cause the computer to perform a method of tracking visa compliance of a person, the method comprising the steps of:
receiving and storing payment card data associated with a payment card associated with the person;
receiving and storing visa data associated with a country and the person;
identifying transaction data containing a date and a location of transactions performed using the payment card; and
creating immigration status data associated with the person based on the visa data and the transaction data.

20. A network component configured to track visa compliance of a person, by:
receiving and storing payment card data associated with a payment card associated with the person;
receiving and storing visa data associated with a country and the person;
identifying transaction data containing a date and a location of transactions performed using the payment card; and
creating immigration status data associated with the person based on the visa data and the transaction data.
